(19) United States
(12) Patent Application Publication
(10) Pub. No.: US 2022/0398669 A1
(43) Pub. Date: Dec. 15, 2022

(54) WORKFLOW MANAGEMENT SYSTEM FOR CUSTOMER COMMUNICATION SOLUTIONS

(71) Applicant: State Farm Mutual Automobile Insurance Company, Bloomington, IL (US)

(72) Inventors: Gregory A. Miner, Heyworth, IL (US); Janet S. McCarty, Towanda, IL (US)

(21) Appl. No.: 17/838,083

(22) Filed: Jun. 10, 2022

Related U.S. Application Data
(60) Provisional application No. 63/209,137, filed on Jun. 10, 2021.

(51) Int. Cl. G06Q 40/08; G06Q 10/06

(52) U.S. Cl. CPC G06Q 40/08; G06Q 10/0633

(57) ABSTRACT

This disclosure describes systems, devices, and techniques for an insurance workflow management system. A server receives a transaction request from a client device. The transaction request includes a set of insurance related requirements. A unique identifier is generated that corresponds to the transaction request and the set of insurance related requirements from the client device. A template pattern may then be selected from a database based on the insurance related requirements. A template document based on the template pattern is constructed and a tailored document is generated by populating the template document with personalized data.

### RELATED APPLICATIONS

This application claims the benefit of and is a non-provisional of U.S. Provisional Patent Application No. 63/209,137, filed Jun. 10, 2021, and entitled “WORKFLOW MANAGEMENT SYSTEM FOR CUSTOMER COMMUNICATION SOLUTIONS,” the disclosure of which is incorporated by reference herein in its entirety for all purposes.

### BACKGROUND

An insurance company may serve a large number of customers through associated agents and other business partners. Large insurance companies typically insure a large number of customers in a number of states, where the customer and state requirements may greatly vary. These customers and state regulators may have unique documentation and/or regulatory requirements that include unique reporting and contact information. Thus, when preparing communications for agents and business partners, an insurance company may evaluate a large number of factors. Often this information may be gathered from a number of diverse sources. Moreover, the collection of information may be reviewed by a number of different entities within the insurance organization. Present industry practice typically has the requisite information distributed over a large number of sources. Often materials are available in paper form from a particular source. In other cases, for example where data may be stored electronically, a wide variety of data formats and application programs are used by the agents and business partners. These data formats are often incompatible for the automated exchange of information. The processes employed by insurance companies at present are therefore time consuming and manual processes that gather data from numerous sources and exchange such information among reviewing entities in paper form.

### SUMMARY

This disclosure describes systems, devices, and techniques for automated workflow management in the insurance industry. A workflow management system allows insurance professionals to define, design and test insurance solutions based on a set of insurance related requirements and pre-defined template documents. The insurance related requirements may be collected from a business partner that indicates of defines the type of document or communication to be created. Based on these insurance related requirements, a design pattern for the template document may be automatically selected. Once a design pattern has been selected, a template document may be created based on the insurance related requirements and the selected template pattern. The template document may then be reviewed and tested by insurance professionals, such as insurance carriers, business partners, insurance agents, insurance agencies, and the like prior to production of the final document.

In an example of the present disclosure, a method for operation of an insurance workflow management system includes receiving a transaction request from a client device, the transaction request including a set of insurance related requirements in which to identify a template pattern. The method also includes generating a unique identifier that corresponds to the transaction request and the set of insurance related requirements from the client device, and selecting the template pattern from a database coupled to the server and storing a plurality of template patterns, the template pattern selected based on the insurance related requirements. The method further includes constructing a template document based on the template pattern selected, and generating, a tailored communication document by populating the template document selected with personalized data received by the client device. The method also includes sending a first communication associated with the unique identifier and including the tailored communication document to the client device.

In another example of the present disclosure, a server in an insurance workflow management system, includes one or more processors; and one or more non-transitory computer-readable media storing computer-executable instructions that, when executed, cause the one or more processors to perform operations includes receiving, by a server in the insurance workflow management system, a transaction request from a client device, the transaction request including a set of insurance related requirements in which to identify a template pattern. The server also includes generating, by the server, a unique identifier that corresponds to the transaction request and the set of insurance related requirements from the client device; selecting, by the server, the template pattern from a database coupled to the server and storing a plurality of template patterns, and the template pattern selected based on the insurance related requirements. The server further includes constructing, by the server, a template document based on the template pattern selected and generating, by the server, a tailored communication document by populating the template document selected with personalized data received by the client device. The server also includes sending, by the server, a first communication associated with the unique identifier and including the tailored communication document to the client device.

In still another example of the present disclosure, one or more non-transitory computer-readable media storing instructions that, when executed by one or more processors, cause the one or more processors to perform actions including collecting, by a server, insurance data from a client device, the insurance data including a request to the server. The one or more non-transitory computer-readable media further includes selecting, by the server, a template pattern based on the insurance data in the request and constructing, by the server, a template document based on the template pattern, wherein the template document is populated with personalized data to form a tailored document.

Various implementations of the present disclosure will now be described with reference to the accompanying figures.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example of a workflow process server environment in which automated workflow processes are performed for insurance document review and processing.

FIG. 2 illustrates an example flow diagram for defining a solution in the insurance workflow management system shown in FIG. 1.

FIG. 3 illustrates an example of a transaction request for use in the insurance workflow management system of FIG. 1.

FIG. 4 illustrates an example of a database storing multiple transaction requests.

FIG. 5 illustrates an example of a template pattern for use in the insurance workflow management system of FIG. 1.

FIGS. 6A and 6B illustrate example process flows for selecting template patterns in accordance with FIG. 2.

FIG. 7 illustrates an example flow diagram for design and development of documents in the insurance workflow management system of FIG. 1.

FIG. 8A illustrates an example flow diagram for testing documents in the insurance workflow management system of FIG. 1.

FIG. 8B illustrates and example flow diagram for generating a tailored version of the approved template document.

FIG. 9 illustrates an example of a tailored template document for use in the insurance workflow management system of FIG. 1.

FIG. 10 shows an example computer architecture for a computer capable of executing program components for implementing the functionality described herein.

### DETAILED DESCRIPTION

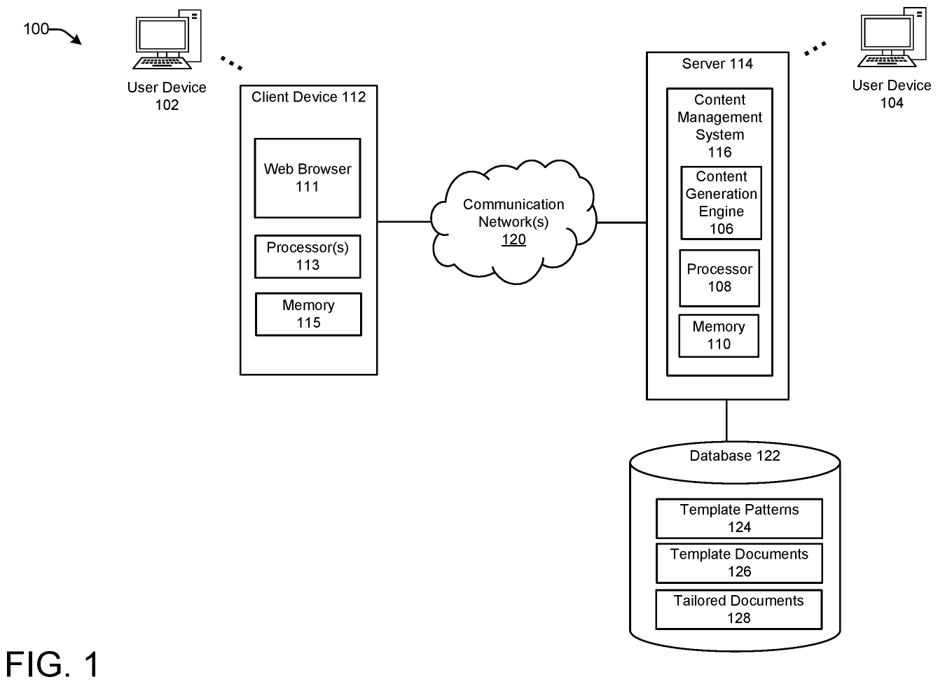

FIG. 1 illustrates an example of a workflow process server environment in which automated workflow processes are performed for insurance document review and processing. As will be explained with respect to FIG. 1, an example insurance workflow management system 100 may be configured to create and/or otherwise facilitate communications for insurance professionals. In an example embodiment, the insurance workflow management system 100 comprises various stages of development in which to define, design and test communications that may be automatically generated by the system. As illustrated, the insurance workflow management system 100 includes a client device 112 and user device input 102, a server 114 and user input device 104, and a database 122 communicating via communication network(s) 120.

The server 114 may be operably connected to a database 122 (or any storage device or system) for storing documents (e.g., template patterns 124, template documents 126 and/or tailored or customized documents 128), and definitions of tasks of the workflow. The server 114 can be further configured to coordinate and monitor automated workflow of insurance related documents. In one example, the server 114 includes a content management system 116. In an example embodiment, the server 114 and/or content management system 116 is operated by an insurance company. The content management system 116 may be used to manage content, such as documents (e.g., word processing documents, spreadsheet documents, graphics documents, etc.), or other content, such as technical data, purchasing data, customer data, etc. For purposes of discussion herein, the content management system 116 is used in connection with managing documents.

In an example embodiment, the content management system 116 includes a content generation engine 106. The content generation engine 106 may be configured to access templates and user-provided content or data stored in database 122 and/or over communication network(s) 120. Using the templates and user-provided content or data, the content generation engine 106 may generate content that is suitable for presentation to customers or clients, such as business partners or third parties. For example, if the content is documents, content generation engine 106 may be configured to access document templates stored in database 122 and generate documents and/or communications based on the templates. The templates may include non-tailored document frameworks, and the content management system 116 may be used to generate tailored or custom documents based on the templates and the user-provided content. In some examples, content may include logos or other branding. Content generation engine 106 may also access configuration data, and process user-provided content or data, document templates, generated documents and/or communications, and the like in accordance with the configuration data. In still other examples, the content may be accessed by user input device 102 using a web browser application 111 or third-party programs. For example, the user may access the content to make final changes to the document before it is presented to the content recipient or customer.

Content management system 116 may also include a processor(s) 108 and memory 110. When processor(s) 108 executes the content generation engine 106, memory 110 may temporarily store the instructions and data required for its execution. When the content management system 116 accesses the content generation engine 106, the instructions generated by the content generation engine 106 may be stored as a local copy in memory 110 and processed by processor(s) 108.

While a single server 114 and a single database 122 are depicted, it is appreciated that the server 114 and associated database 122 may be operable within a single data processing node with associated storage devices, or may be distributed over any number of computing and/or storage devices in a distributed processing and/or distributed storage computing environment.

The client device 112 may interact with any number of servers 114 through a user input device 102, such as a workstation, a personal computer (e.g., a desktop, laptop, notebook, etc.), or any other suitable stationary or portable computing device, such as a tablet, phablet, smart watch, smart glasses, smartphone, or other mobile device coupled to the server 114. The client device 112 may include, but is not limited to, a web browser application 111, a processor(s) 113 and memory 115. The client device 112 may be coupled to the user input device 102 that allows a user to enter input to client device 112 and allows the user to view outputs/displays generated by client device 112. In an example embodiment, the user input device 102 may include one or more different input devices, such as a pointing device (such as a mouse, a keyboard, a trackball device, a digitizing tablet and/or a microphone, for example). The user input device 102 may also include one or more output devices, such as a display monitor. Using the user input device 102, users are able to interact with graphical user interfaces (GUIs), such as a web browser application 111, provided by the client device 112. In an example embodiment, the users of the user input device 102 may be entities (e.g., corporate entities, governmental entities, non-profit entities, business partners, etc.) and/or users that are private individuals (e.g., individuals acting on their own behalf). In one example, the user interface includes onscreen elements arranged for selection of a range of inputs (e.g., insurance related requirements).

When processor(s) 113 executes the web browser application 111, memory 115 may temporarily store the instructions and data required for its execution. When the user accesses the web browser application 111, the instructions of the corresponding web page(s) may be stored as a local copy in memory 115, and the web browser application 111 may interpret the instructions of the local copy. When interpreting the instructions, the web browser application 111 may present the GUI to the user and may allow the user to interact with the presented GUI.

In one example, a user at the user input device 102 may send a transaction request to server 114 via communication network(s) 120. Similarly, the server 114 may interact with any number of client devices 114 through a user input device 104. In an example embodiment, the user input devices 102 and 104 may be operated by internal users (e.g., internal to an insurance company), such as a business entity, insurance reviewer, insurance reviewer entity, insurance agents, reinsurance organizations, etc. In an example embodiment, through suitable security mechanisms, the client device 112 (and users at the user input device 102) may be allowed direct access to the insurance workflow management system 100 to enable direct input of data and to enable review of user provided content or data, document templates, generated documents and/or communications, and the like by trusted, secured, related parties. It is appreciated that any number of external users or entities and any number of internal users or entities may be coupled to such a computing environment using a wide variety of computer communications techniques and structures.

In general, a user at user input device 102 initiates workflow processing at client device 112, which sends a transaction request to the server 114. The transaction request provides insurance related requirements for a particular solution (herein, a “solution” can be understood as the generation of one of sonic number of documents and/or communications). For example, the transaction request may be requesting an automated workflow be performed to generate an insurance document. The insurance related requirements may be entered by the user of client device 112 (e.g., a business partner of the insurance company) via a GUI. The insurance related requirements input into the user input device 102 are generally in the form of responses to queries pertaining to insurance coverage, the responses determining content of one or more documents or forms to be constructed for purposes of insurance coverage. The collected responses, which define the requirements for the transaction request, may be entered into and stored in a database 122 as an inventory item associated with a unique identifier (UID), explained further below.

In an example embodiment, the insurance related requirements may be automatically extracted from other documents or images scanned or otherwise input into the system. For example, documents may be entered and stored into the database 122 by digitizing through a scanner and optical character recognition (OCR) techniques may be applied to extract text from the scanned documents.

in either case, the insurance related requirements sent as part of the transaction request by the client device112 to the server 114 initiates a set of tasks in which to generate the requested insurance document. In an example embodiment, the tasks definitions generated as part of the workflow process are generated by the server 114 and may be stored in the database 122 and associated with the UID. The database 122 may be implemented as an indexed file structures and techniques including, for example, hierarchical or relational databases, object-oriented databases, etc. Additionally, commercially available document management systems may be used to store and manage such tasks definitions and databases.

As will become apparent in the discussion that follows, automated workflow processing aspects of the disclosure may include a number of tasks and related processes coordinated and monitored by the workflow processing operable in the server 114. In general, workflow processing aspects include generation of a number of tasks associated with review processes normally performed by an insurance entity or professional. Such processes were conventionally performed manually such that processing was slowed by human interaction in exchanging user-provided content or data and communications in response, and the like and was often error prone due to human induced errors.

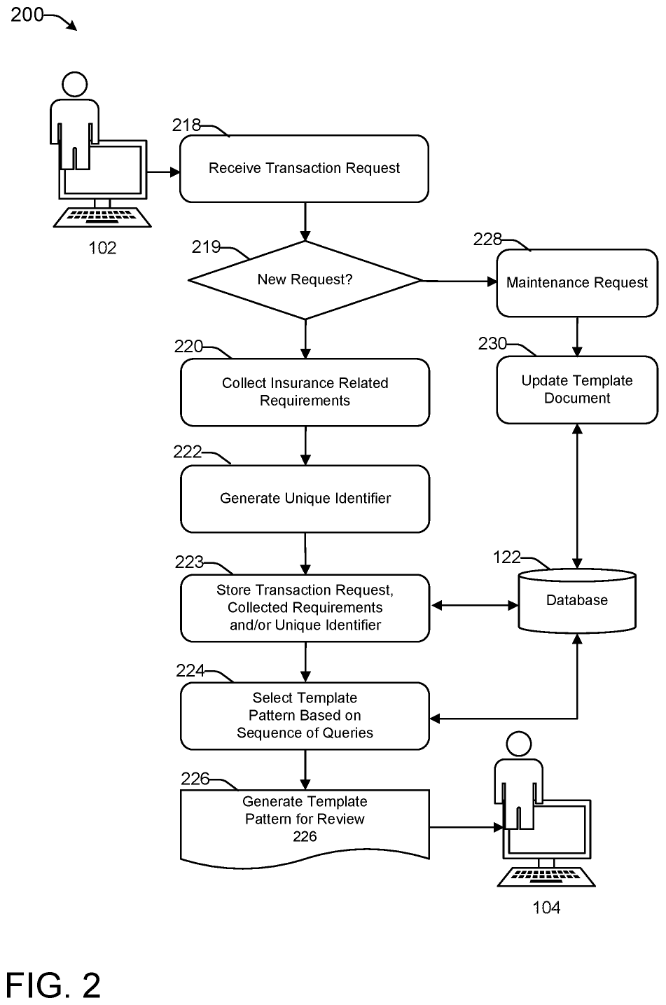

FIG. 2 is an example flow diagram illustrating a process 200 for defining a solution in the insurance workflow management system 100 shown in FIG. 1. In the discussion that follows, the server 114, including the content management system 116, performs the process 200. However, it is appreciated that any other functional unit or processing unit may implement the processes described herein, and the disclosure is not limited to implementation by the data management system. The workflow process may be performed by scheduling a number of tasks to control the sequencing of the review processes, to control the reviewing entities responsible for various reviews and to monitor progress of the various tasks and related reviews. The number of manual steps in such an automated workflow procedure is dramatically reduced as compared to prior processes. Such a reduction in manual intervention improves process speed and reduces errors in the development and processing of content, such as documents.

The process 200 begins at operation 218, where users of a client device, such as client device 112. provide a transaction request to server 114 via communications network(s) 120. The transaction request may be input, for example, by a user via the web browser application 111, such as a GUI, on the user input device 102. More specifically, the web browser application 111 may be configured so a user of an entity, such as a business partner, can enter responses reflecting information about the entity and respond to various questions posed by the insurance company. For example, as explained below, the GUI may present questions on a display of the user input device 102 for the user to answer.

Upon receipt of the transaction request, at operation 219, the server 114 determines whether the transaction request is a request to create a new transaction request record or to update (maintain) an existing transaction request record. In an example embodiment, the server 114 accesses the database 122 to determine whether any record exists that corresponds to the transaction request. For example, the transaction request may be associated with a unique identifier that is stored and indexed in the database 122. If a record in the database 122 matches the unique identifier associated with the transaction request, then the transaction request is determined to be a maintenance request and the process continues to operation 228, discussed further below. In an example embodiment, the user entering the transaction request may identify that the request is for a transaction record update. For example, the transaction request mar include a request to update (i.e., maintain) insurance content, such as an ID card, a questionnaire, declaration pages, a policy, a policy renewal, endorsements, coverages, invoices, or any other insurance related content. If no record exists in the database 122 that matches the UID associated with the transaction request, then the process proceeds to operation 220.

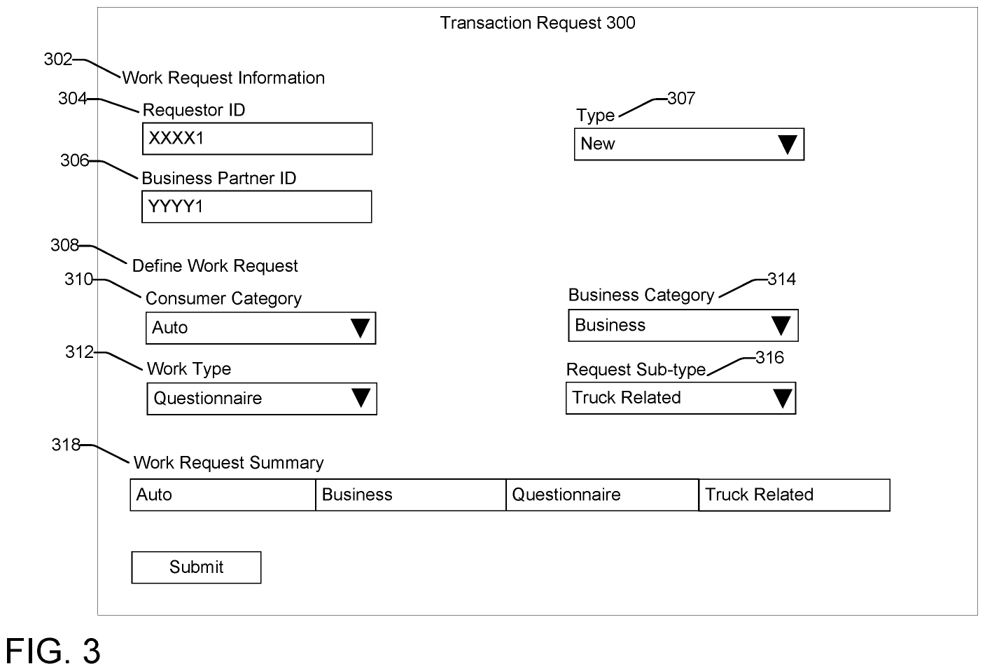

At operation 220, after receipt of the initial transaction request by the client device 112 and identifying the transaction request as a request to create a new request record, the server 114 begins collecting a set of insurance related requirements from the client device 112. In an example embodiment, the insurance related requirements may be included as part of the transaction request record. An example of a transaction request is illustrated in FIG. 3, described below. The transaction request 300 may include, as noted above, insurance related requirements or parameters that are entered by a user of the user input device 102 in which to acquire response information to assist in defining a template pattern to be selected by the content management system 116 of the server 114.

In an example embodiment, with continued reference to FIG. 3, the web browser application 111 executes on the user input device 102 and includes an entry screen in which the user may enter response information about the transaction request 300 and insurance related requirements about the transaction request 300. For example, the server 114 may collect a set of insurance related requirements or parameters in response to the user answering questions as part of the transaction request 300. In the illustrated example, and for purposes of discussion, the transaction request 300 and corresponding insurance related requirements are directed to an operations questionnaire, although the transaction request is not limited to such an example. In this case, the web browser application 111 queries the user to collect a set of insurance related requirements in the work request information field 302 in which to identify the requesting party (i.e., the party that sent the transaction request), such as a requestor ID 304, a business partner ID 306. The web browser application 111 may also query the user to determine whether the transaction request 300 is a new request or a request to update or maintain an existing request. This may be accomplished, for example, using the pull-down menu labeled type 307. For example, the user may select the work request as a “new” request, an “updated” request, or an “auto” request (in which the system automatically determines whether the transaction request is a new request or an updated request).

in work request field 308, the web browser application 111 may also instruct that the user define a work request. The define work request field 308 may further aide in defining the specific type of transaction request 300 by requesting response information related to consumer category field 310, work type field 312, business category field 314 and request sub-type field 316. Once the fields have been populated, a work request summary 318 may be displayed as part of the transaction request 300. In an example embodiment, the fields displayed on the web browser application 111 may include a drop-down menu in which to select a category or type. In an example embodiment, the web browser application 111 may display a list of available options to the user and allow the user to select options that correspond to a particular field that is relevant to the transaction request 300. The selected option may then populate the respective field. For example, the consumer category may include a drop-down menu in which a list of options may be displayed. The list of options may include, for example, auto, boat, home, etc. from which to select. In an example embodiment, as the user populates fields with a selection, the work request summary 318 may be updated.

Turning back to FIG. 2, at operation 222, the client device and/or server 114 may generate a UID that will uniquely identify the transaction request 300 in a database, including the collected insurance related requirements. The UID may be a numeric or alphanumeric string that is associated with a single entity, transaction, document or otherwise. In an example embodiment, the UID is randomly generated, for example, by a random number generator. In another embodiment, the UID is generated based at least in part on the requestor ID and/or the business partner ID. The transaction request 300, including the collected insurance related requirements, may be stored in the database 122 wherein it is uniquely identified by the UID at operation 223. In one example, the transaction request 300 and insurance related requirements may be indexed in the database 122 according to the UID, such that a database lookup operation by any UID returns only one transaction request 300. The unique identifier may be used to track the transaction request 300, and any communications or documents generated as a result of the transaction request 300, throughout the workflow process.

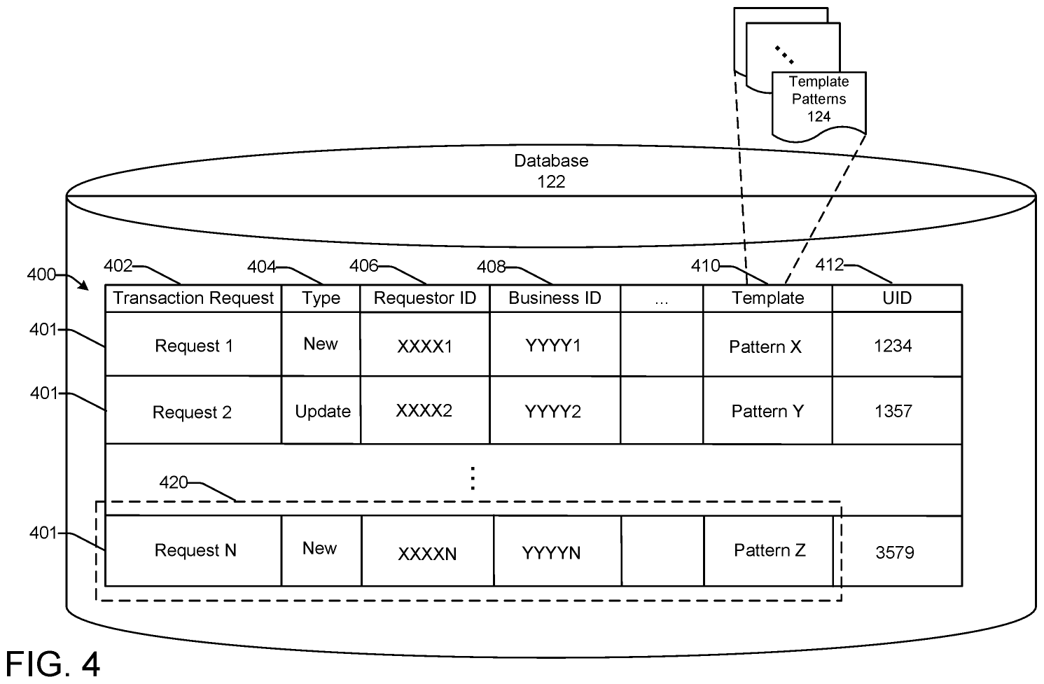

One example of a database storing multiple transaction requests 300 is shown in FIG. 4. As illustrated, database 122 stores a data structure 400 (e.g., table or list) of transaction request records 401 and corresponding insurance related requirements and/or template patterns, which may be associated with a UID. The data structure also enables the insurance workflow management system 100 to index content stored in the database 122. The transaction request records 401 in the data structure 400 includes several fields, such as the transaction request field 402, the type field 404, the requestor ID field 406, the business ID field 408, the template field 410 and the UID field 412. Fields 402-410 together may be referred to herein as an inventory item 420.

In an example embodiment, data structure 400 is a table that may be implemented as a relational table in which the meaning or data type of a particular field is defined as a function of the position of the field within the table. For example, a relational schema may be specified for the table that explicitly defines the first column of the table to correspond to transaction request data, the second column to type data, and so forth. In an alternative embodiment, the table may be implemented as a collection of records in which the meaning of a field does not depend on the position of the field within the record, but instead is indicated by an explicit tag associated with the contents of the field. For example, the records comprising the table may be formatted in a suitable markup language, such as a markup language (e.g., extensible markup language (XML)).

In an example embodiment, the database 122 can optionally store other metadata about the inventory item 420, such as the source of the inventory item, a time indicator for when the inventory item was originally posted at a source, a time indicator for when the inventory item was received by the server 114, and the like. Time indicators in particular may be useful in establishing a queue of inventory items 420 in the database 122 that sets out an approximate order in which to review and process tasks and requests.

In one example with continued reference to FIG. 3, the data structure 400 contains three sample transaction request records 401—Request 1, Request 2 and Request N. For instance, the first row of the data structure 400 is populated with the insurance related requirements provided in a transaction request 300 and associated with a UID of UID field 412. Specifically, in the example, the data structure is populated with a transaction request field 402 labeled “Request 1” with corresponding insurance related requirements as Type field 404 labeled “New,” a Requestor ID 406 field labeled “XXX1,” Business ID field 408 labeled “YYY1,” and a template field 410 labeled “Pattern X” (based on the selected template pattern 124. In this case, fields 402-410 form the inventory item 420, which is associated with the UID 411 labeled “1264.” As additional transaction requests 300 are received by the server 114, they are stored in the database 122 as respective transaction request records 401 populated with the relevant information in each field. Although the depicted embodiment shows data stored in the form of a table, it is appreciated that the data may be stored as any data structure or format and is not limited to a table format.

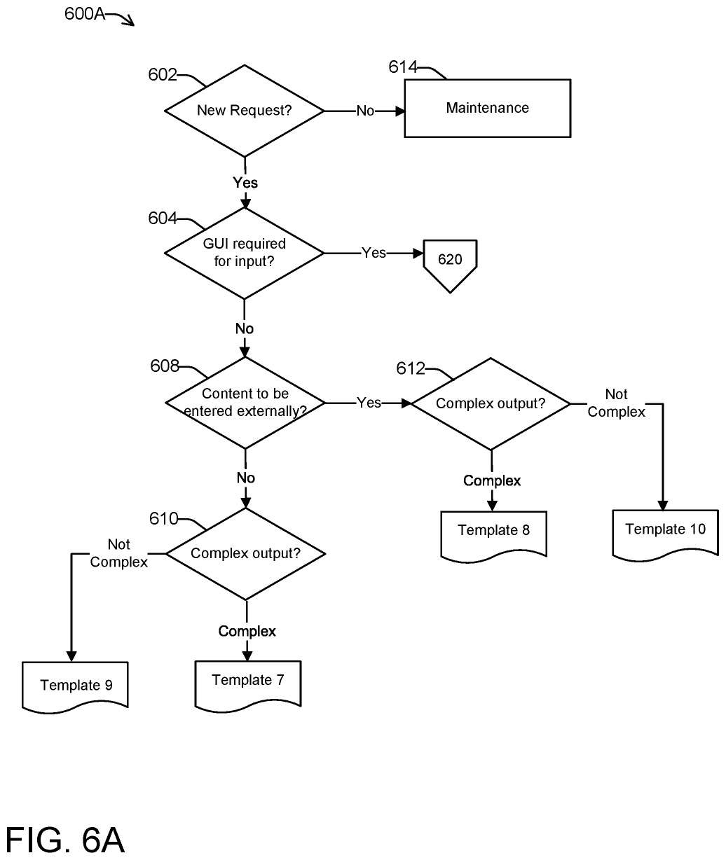

Turning back to FIG. 2, at operation 224, the server 114 selects a template pattern 124 identified from the transaction request 300 and insurance related requirements, discussed further below with reference to FIGS. 6A and 6B. In an example embodiment, multiple template patterns 124 are stored in the database 122. In another embodiment, a list of the template patterns 124 is stored in the database 122 with a pointer to a storage location in which the template patterns 124 are stored. In still another embodiment, the template patterns 124 may be stored in memory 110 of the server 114 and/or in the memory 115 or the client device 112. The template patterns 124 may include a unique pattern that may be selected by the content generation engine 106 of the server 114 based on the transaction request 300, including the insurance related requirements, received from the client device 112.

In an example embodiment, the template patterns 124 allow data from a variety of sources to be laid out on a common page in a manner that presents a visually aesthetically appealing design. In an example embodiment, the template pattern 124 is described by a spatial arrangement or layout by which data may be arranged for presentation on a display of a user device or on a physical document. The template patterns 124 may be comprised of one or more input fields or slots that hold content. For example, an input field of the template pattern 124 may be populated with data acquired from the client device 112 or entered manually by a user. These template patterns 124 are examples of the templates that may be stored in and retrieved from the database 122 of the content management system 116. In implementation, any number of template patterns 124 can be used, providing a useful variety of different page layouts and patterns. In an example embodiment, the template pattern 124 may be defined, for example, in JSON format, and be designed by a human with aesthetic sensibilities, rather than being designed by an automatic algorithm. In another embodiment, the template pattern 124 may be generated by an algorithm based on the transaction request record 401 and/or insurance related requirements provided by the client device 112.

In an example embodiment, the template pattern 124 has a pre-defined pattern. For example, the template pattern 124 may be related to insurance documents in a specific category and/or with a specific pattern. Examples of template pattern categories include, but are not limited to, mailings; auto ID cards; renewals; invoices; endorsements; compliance to ensure that industry standards and rules are being met; an auto insurance policy; homeowner's insurance; personal insurance; state specific compliance categories; federal compliance standards; certificates of insurance; claims cost containment; declaration sheets; coverage agreements; exclusions to coverage; terms and conditions; definitions and/or any other template category or pattern.

Once the template pattern 124 has been selected at operation 224, the template pattern 124 may be generated at operation 226 for review by one or more entities associated with the insurance workflow management system 100.

If the server 114 determines that the transaction request is a request to maintain or update an existing transaction request record, the process 200 proceeds to operation 228. In this case, any changes made to the insurance related requirements in the transaction request will cause the server 114 to update the template document 126 in the database 122, at operation 230. For example, the user of client device 112 may actively request changes to the specific transaction request labeled “Request 2” in database 122 (FIG. 4). Based on this specific request, the template pattern 124 associated with “Pattern Y” may be updated in the database 122. In another example, the server 114 may automatically determine that the user is requesting an update by identifying an existing record in the database 122 for the requested transaction. For example, the user may be requesting a change to the inventory item 420 associated with UID “1357.” Similar to the other example, the template pattern 124 associated with UID 1357 will be updated in the database 122.

With reference to FIGS. 6A and 6B, an example process flow for selecting template patterns 124 in accordance with FIG. 2 is shown. In the discussion that follows, the server 114, including the content management system 116, performs the procedures. However, it is appreciated that any other functional unit or processing unit may implement the processes described herein, and the disclosure is not limited to implementation by the data management system.

The selection of template patterns 124 in process 600A is based on a sequence of queries beginning with operation 602, as depicted. At operation 602, the server 114 determines whether the transaction request 300 received by the client device 112 should be created as a new transaction request record 401 or is a request to maintain an existing transaction request record 401, already stored in database 122. If the server 114 identifies the transaction request 300 as a request to update a transaction request record 401, as discussed above, then the process 600A proceeds to operation 614 and the transaction request record 401 is updated to reflect the updated information in its fields. If the transaction request 300 should be created as a new transaction request record 401 at operation 602 by the server 114 (e.g., the transaction request has not been previously requested), then the process 600A proceeds to operation 604.

At operation 604, the server 114 determines how the insurance related requirement information, which may be attached to the transaction request 300, have been provided by client device 112. In an example embodiment, the insurance related requirements are input by a user of the client device 112 at user input device 102. For example, a user may enter the insurance related requirements into the user input device 102 via a GUI, such as web browser application 111. In this case, the process 600A proceeds to operation 620, discussed further below with reference to FIG. 6B. In another embodiment, the insurance related requirements may be sent to the server 114 as an electronic communication, such as an electronic file, or stored in a database that is accessible to the server 114. In this case, the GUI is not required to retrieve the insurance related requirements from the client device 112. The process proceeds to operation 608.

At operation 608, the server 114 determines whether content will be entered by an external entity (i.e., external to the server 114, including the content management system 116). In an example embodiment, different tools (such as a third-party design application) may be used to externalize content in a document. For example, a business partner can use a tool to update content in the document. The tool may be, for example, a software application that enables entry or modification of content into the document. In one example, the content in a template pattern 124 having a customer specific paragraph may be updated. For example, a paragraph in the document may relate to insurance regulatory issues. The insurance regulatory issues may be state-specific and controlled based on a geographic location of the customer receiving the document.

If the server 114 determines at operation 608 that content will be entered by an external entity, then the process 600A proceeds to operation 612. At operation 612, the complexity of the output document (e.g., template pattern 124) is determined by the server 114. For example, the server 114 may determine whether the template pattern 124 will include text, tables, charts, graphical designs, logos, etc. If the template document 126 is determined to not be complex, then a first template pattern (e.g., template 10) is retrieved from the database 122. For example, the document being output may include text. If the template document 126 is determined to be complex, then then a second template pattern (e.g., template 8) is retrieved from the database 122. For example, the document being output may include one or more graphics that require modification using a third-party application.

If the server 114 determines at operation 608 that content will not be entered by an external entity, then the process 600A proceeds to operation 610. At operation 610, the complexity of the output document (e.g., template pattern 124) is determined by the server 114. For example, the server 114 may determine whether the template pattern 124 will include text, tables, charts, graphical designs, logos, etc. If the template document 126 is determined to not be complex, then a third template pattern template 9) is retrieved from the database 122. For example, the document being output may include text. If the template document 126 is determined to be complex, then then a fourth template pattern (e.g., template 7) is retrieved from the database 122. For example, the document being output may include one or more graphics that require modification using a third-party application.

Returning to operation 604, when the user enters the insurance related requirements into the user input device 102 via a GUI, such as web browser application 111, the process proceeds to operation 620 of process 600B in FIG. 6B. At operation 620, the server 114 determines whether the response information (e.g., insurance related requirements) entered into the GUI have been provided in the form of data, such as a suitable markup language XML), or as a communication with an attachment, such as PDF document that includes the insurance related requirements entered into the GUI. When the response information is in the form of data, the server 114 selects a fifth template pattern (e.g., template 2) at operation 620. Otherwise, the server 114 determines that a communication, with an attachment, has been provided by the client device 112 and the process 600A proceeds to operation 622.

At operation 622, the server 114 determines whether the data or communication (i.e., input) received from the client device 112 requires an output that is the same or similar to the provided data or communication. In an example embodiment, the requirement for the output to be the same or similar to the input is based upon a specific third-party design application being employed. In another embodiment, the user requests that the output and input look the same or similar. If the server 114 determines that the output is the same or similar to the input, then the server 114 determines whether the requesting party would like to see a preview of the output prior to template pattern selection at operation 628. If a preview is desired, then a sixth template pattern (e.g., template 2) is selected. If a preview is not desired, then a seventh template pattern (e.g., template 1) is selected.

Operations 624, 626 and 630 (annotated with a dashed line in the figure) function the same as operations 608, 610 and 612, although different template patterns (e.g., templates 3, 4 and 5) are selected based on the complexity of the output.

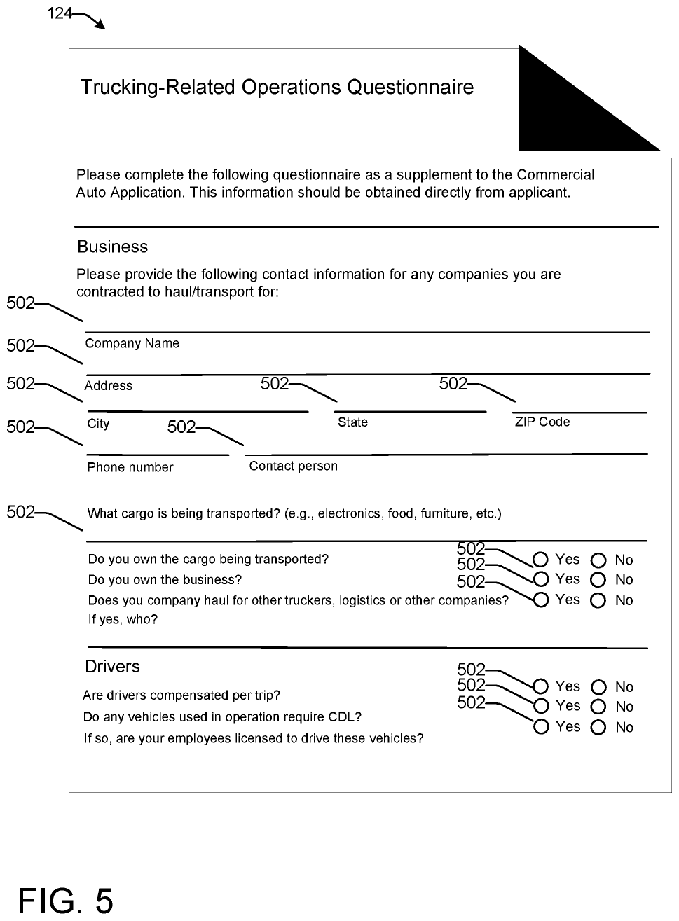

One example of a template pattern 124 is illustrated in FIG. 5. As shown, the template pattern 124 has been generated based on the example transaction request 300 and corresponding insurance related requirements of FIG. 3, For example, the transaction request 300 defines the work request in the consumer category field 30 as “auto” the work type field 312 to be a “questionnaire” for a business category field 314 of “business” and a request sub-type field 316 of “truck related.” As a result, the server 114 selects a template pattern 124 that has a pattern for “Trucking-Related Operations Questionnaire.”

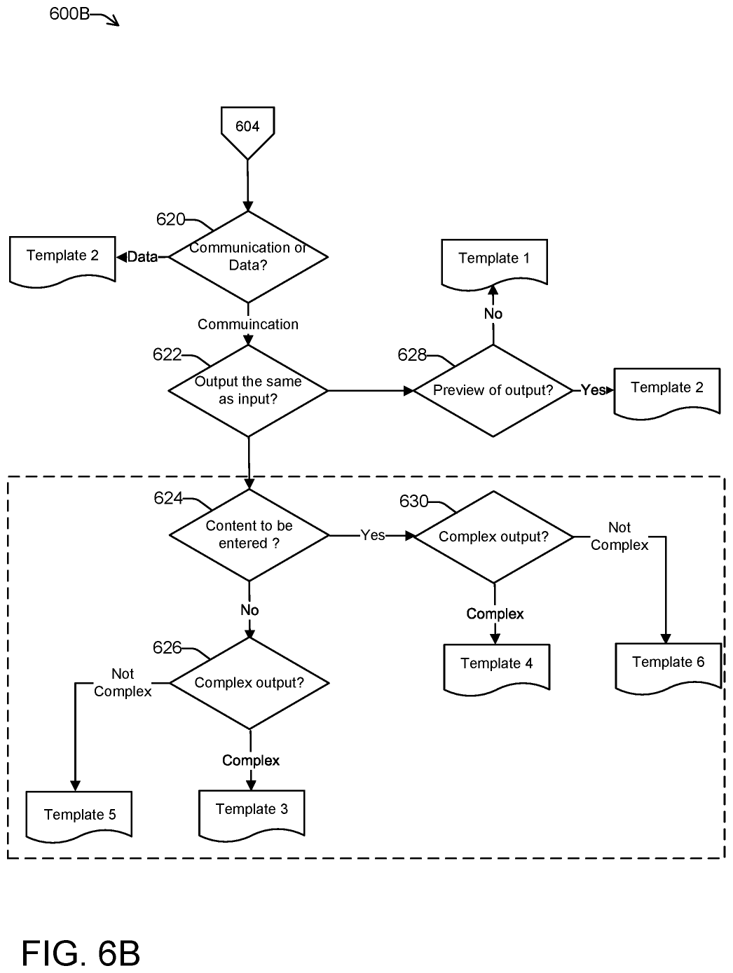

FIG. 7 is an example flow diagram for design and development of documents in the insurance workflow management system 100 shown in FIG. 1. In the discussion that follows, the server 114, including the content management system 116, performs the process 700. However, it is appreciated that any other functional unit or processing unit may implement the processes described herein, and the disclosure is not limited to implementation by the data management system.

Operation 702 shows the server 114 collecting the set of insurance related requirements from the client device 112. In an example embodiment, the insurance related requirements may be included as part of the transaction request 300. As noted above, an example of a transaction request is illustrated in FIG. 3. The transaction request 300, including the insurance related requirements, may be stored in the database 122 and associated with the unique identifier at operation 704. One example of a database storing multiple transaction requests 300 is shown in FIG. 4. The template pattern is then selected according to the sequence of queries illustrated in FIGS. 6A and 6B, as described above.

At operation 704, the server 114 assigns a set of tasks to the business entity responsible for handling constructing the template document 126 for the review and development of the template document 126. As used herein, the term task refers to the discrete activities that are to be performed in order to review and/or complete the processing of a transaction request 300. Thus, the transaction requests 300 may be associated with different tasks or combinations of tasks. Any number of tasks may be generated and monitored by the server 114 based on the information collected by the server 114 during operation 702. The review of information at various stages assures continued progress and improved quality of the template documents 126, as well as the template pattern 124 selected. The tasks, which can be stored in the database 122, may include reference to an associated document, for example using the UID, as well as a reference to a related party or business entity associated with the document and the task. This enables the system to track progress of documents as it progresses through the review and development stage.

At operation 706, a communication including the set of assigned tasks are sent to the business entity responsible for review and development of the transaction request 300.

As part of operation 704, sub-operations 708 and 710 may be performed by the server 114. At sub-operation 708, the server 114 initiates the set of tasks assigned to the business entity to review the template pattern 124 previously selected. The review may be based on, for example, an analysis of the insurance related requirements included in the original transaction request 300 to verify that the template pattern 124 selected conforms to the original request. Any number of different tasks may be assigned to a business entity and/or performed by the server 114 as an automated process.

In general, tasks created during workflow processing may include an attribute indicating the type of reviewing entity responsible for review of the document and associated information. Such entities may include, for example, reviewers within an insurance company, such as licensing reviewers, appointment reviewers, legal reviewers, data entry reviewers, etc. While awaiting acceptance of such tasks, other new transaction requests and template patterns may be received and processed. When new tasks are created for the incoming transaction requests, a queue in the database 122 may identify a list of presently incomplete tasks. These incomplete tasks may accumulate as newly arriving tasks await acceptance by an appropriate reviewing entity. In an example embodiment, tasks may be stored in the database 122 and annotated with a status, such as “complete” or “incomplete.” For example, a task related to an inventory item 420 (e.g., record) may indicate the present status of the task as complete or incomplete. Incomplete tasks may be further subdivided into those that are “ready” (i.e., awaiting review) and those that are “pending” (i.e., suspended awaiting some further input or processing by a reviewing entity).

In an example embodiment, reviewing entities within the insurance company may gain access to the server 114 through an appropriate secured communication means capable of displaying information from the server and receiving input from the reviewing entity. For example, the server 114 may present user-provided content or data, document templates, generated documents and/or communications, and the like to the reviewing entity and may receive input from the reviewing entity using standard Web based client/server technology. For example, the server 114 may provide Web service capabilities responsive to a web browsing application operable on the user input device 104 used by the reviewing entity. When an appropriate reviewer accesses the web browsing application, the reviewing entity may indicate acceptance of any of the incomplete tasks appropriate for review by that entity. Upon indicating acceptance of such an incomplete task, the status may be updated to a completed task in the database 122.

One example of a task is a quality check task. The quality check task, for example, may be assigned to provide a peer review of a new transaction requested. In one example, the quality check task verifies the propriety of a preliminary approval of a transaction request 300, including template pattern 124. A second reviewing entity (e.g., a reviewer) within the business entity reviews the preliminary approval to verify the propriety of submitted template pattern 124. The reviewer may verify and, if necessary, correct transaction request records 401 recorded in the database 122 relating to the initially approved request. Once approved by the second reviewing entity, processing of the quality check task may be completed, and the status updated in the database 122.

Another example of a task is a general correspondence task. The general correspondence task may be assigned to a reviewer of the business entity. For example, a general correspondence may be received at the server 114 and recorded in the database 122. The general correspondence task may include, for example, an update to correct a spelling error in the insurance related requirements or provide additional response information inadvertently left out of the original transaction request 300. Upon receipt of the general correspondence, the server 114 may associate, using the UID, the general correspondence received with a previously entered transaction request 300 in the database 122. Once associated with the transaction request 300, a reviewer may complete processing of the general correspondence task and remove the completed task from the database 122 by marking the status as completed.

In an example embodiment, completion of processing a task may result in construction of a template document 126 at sub-operation 710. The constructed template document 126 may have an appearance that matches the template pattern 124 or may have a modified appearance. For example, during the review process, changes or modification may be made to the template pattern 124. Such changes may, for example, be as a result of newly input insurance related requirements or other identifying information that necessitates changes to the template pattern 124. In another embodiment, processing of one task relating to review of a template pattern 124 may result in the generation of one or more subsequent tasks relating to workflow of that template pattern 124. In this manner, the workflow processing generates a sequence of tasks associated with the workflow. The tasks may then be processed by a reviewing entity of the appropriate type as described above. Once all tasks have been completed, the template document 126 may he constructed.

In an example embodiment, the assignment and review of tasks may be automated. For example, the content management system 116 may monitor and generate tasks, or execute tasks, based on transaction requests 300 (including the template pattern selected) received by client device 112 and/or retrieved from database 122. Automated task generation may be based a variety of factors, such as but not limited to, account servicing requirements, company policy, company best practices, regulatory requirements, and customizable tasks in view of the data associated with the transaction request 300. In an example embodiment, tasks may be accessed by the content management engine 116. Tasks may be selected from the database 122. based on rules that match conditions in the transaction request 300 to one or more of the tasks in the database 122. In an example embodiment, the tasks are stored in a storage device or memory that is separate from database 122. At any time during the automated processing of tasks, the task may be redirected to a reviewer at the business entity. For example, the task may be redirected to the reviewer based on predetermined triggers, thresholds and/or scenarios related to and/or determined during performance of the task by the content management engine 116. In an example embodiment, rules and preferences stored in the database or memory may initiate performance of testing. For example, the rules and preferences can maintain a schedule of tests to automatically perform tests for a template pattern 124 at specific time intervals. The rules and preferences can also include instructions for determining when a test is started or completed.

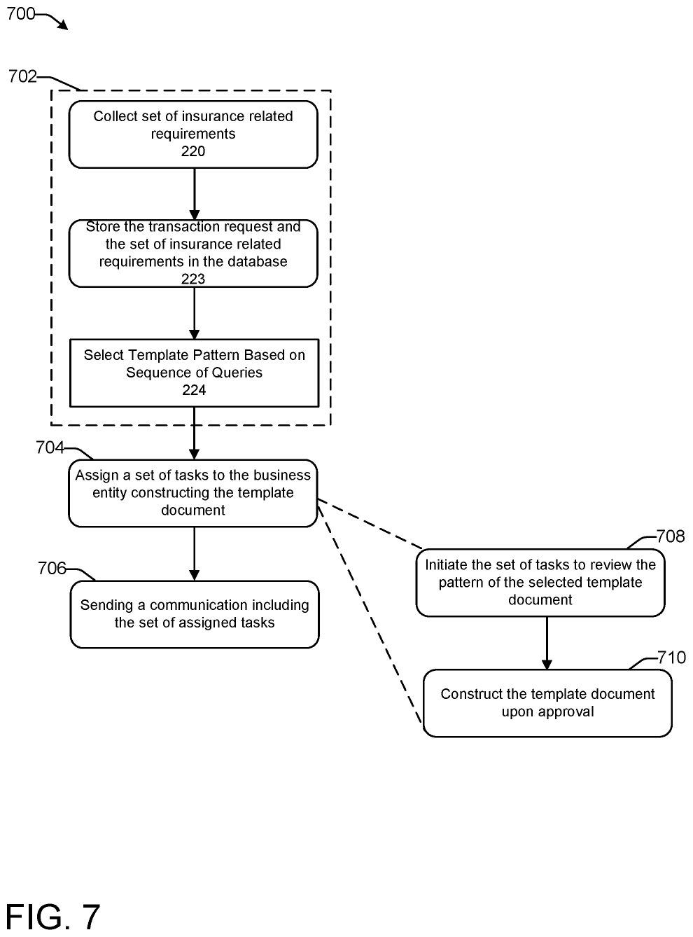

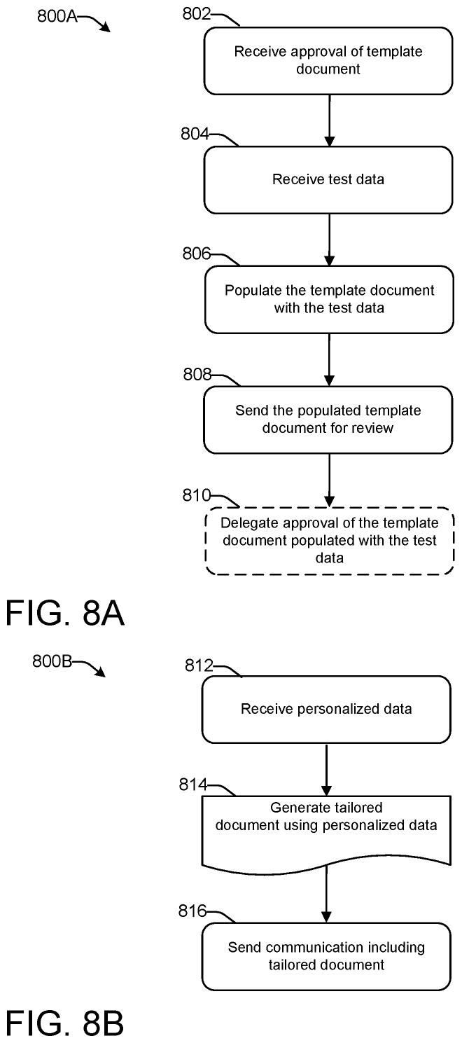

FIG. 8A illustrates an example flow diagram for testing documents in the insurance workflow management system 100 shown in FIG. 1. In the discussion that follows, the server 114, including the content management system 116, performs the process 800A. However, it is appreciated that any other functional unit or processing unit may implement the processes described herein, and the disclosure is not limited to implementation by the data management system.

The process 800A begins at operation 802, where the server 114 receives a communication from a business entity or partner that the template document 126 has been approved.

Once the template document has been approved, the server 114 receives test data in which to populate an approved template document 126, at operation 804. The test data may be retrieved from the database 122, provided by the client device 112, submitted by the server 114 via the user input device 104 and/or submitted by a third-party or any other entity. The test data is, for example, data which has been specifically identified for use in testing of the template document. Some data may be used in a confirmatory way, typically to verify that a given set of input produces some expected output result. For example, the test data may be similar to the personalized data described subsequently.

At operation 806, the input fields of the template document 126 are populated with the test data retrieved from database 122. For example, the input fields for an insurance form (i.e., the template document) are pre-filled or populated using the test data received in operation 804. In an embodiment, the server 114 may be configured so that the populating can be performed in real time, such that test data retrieved for use for populating is retrieved within a time period of less than 1 second, or less than 10 seconds, after receipt of the test data. In one example, the test data may be parsed and/or structured for classification and populating. For example, the classification may be used to populate a particular input field in the template document 126 related to the classification. The server 114 may also intelligently populate portions or gaps in the test data, such as populating one or more input fields in the template document 126. For example, the server 114 may populate an address input field, a company business name input field, a phone number input field of the company, a number of vehicles owned by the entity input field, etc.

As discussed above, the server 114 may populate certain information in the template document 126 based on test data retrieved from the database 122. The server 114 may also acquire test data from one or more other applications (e.g., a third-party database) in order to populate portions of the template document 126. For example, the server 114 may retrieve updated addresses from a third-party database and may use the updated addresses to populate fields in the address input field of the template document 126. In another embodiment, a user of the user input device 104 may specify a particular source from which to retrieve the test data. For example, the user may specify that the addresses in the test data should be acquired from a particular database table related to address information.

Once the test data has been added to the template document 126, the document may be sent for review and final approval at operation 808. In an example embodiment, final approval of the template document 126 may be optionally delegated to a business entity and/or reviewer at the business entity at operation 810. Review and approval of the template document 126 is similar to the review and approval of the transaction request 300 including the insurance related requirements, as discussed above with reference to FIG. 7. For example, the review may be based on an analysis of the test data populated in the template document 126 to verify that the populated template document conforms to the original transaction request 300. In doing so, and similar to the review of template patterns, any number of different tasks may be assigned to a business entity and/or performed by the server 114 as an automated process. For example, a performance task may be assigned to the business entity and/or performed by the server 114. The performance task may be driven, for example, by the requirements of the party originally requesting the transaction request 300 and/or measured against various standards in like industries (e.g., benchmark testing). In an example embodiment, a user of the client device 112 originally sending the transaction request 300 may review or pre-view the template document 126 for completeness, prior to generating a final version of the template document 126.

In an example embodiment, the performance test may be executed via a GUI, such as a web browser application. In some configurations, the GUI can include a window or an area where a user may select and browse the template document 126 under review and testing. The GUI can receive specific settings or commands from the user to control the testing, for example, by modifying parameters and/or define output results. For instance, the user can define specific requirements, parameters or testing metrics, such as color, font size, or input field size for the performance test through the GUI. As another example, the user can specify what information should be presented in the output, such as a performance message or alert, pass or fail results, errors, etc. In one further example, the user can also configure the format of the template document 126 so as to change the aesthetic output presented on the GUI. For example, the user can set the format to be text or graphical.

In some embodiments, the testing may be performed by the content generation engine 106 as a software tool on any computing device, such as server 114. The content generation engine 106 can include performance testing on one or more template documents 126. Moreover, the content generation engine 106 can perform tests based on one or more parameters or metrics. For example, content generation engine 106 can perform tests based on specific parameters or testing metrics, such as color, font size, or input field size.

Upon completion of review and approval of the template document 126 by the one or more business entities of the insurance company, a communication including the template document 126 may be sent to the business partner or party that sent the original transaction request 300. Upon receiving the approved template document 126, if the business partner wants to modify the approved template document 126, the business partner may reject the approved template document 126 and return the document to the business entity for updating. The reviewers at the business entity may then revise and update the template document 126 based on the revisions specified by the business partner. A revised template document 126 may then be generated and communicated to the business partner for final approval. In an example embodiment, the database 122 may be updated upon final approval to mark the transaction request record 401 as completed.

Once approved, a final version of the template document 126 is ready for production. FIG. 8B illustrates and example flow diagram for generating a tailored version of the approved template document. In the discussion that follows, the server 114, including the content management system 116, performs the process 800B. However, it is appreciated that any other functional unit or processing unit may implement the processes described herein, and the disclosure is not limited to implementation by the data management system.

The process 800B begins at operation 812, where the server 114 receives personalized data from the business partner that provided the original transaction request 300. The personalized data may include any information or data used to populate the template document 126. For example, the personalized data may include a company name, company address, company phone number, company contact person, etc. The personalized data may also include information that responds to queries in the template document 126, such as a response to questions about the company, a response to questions about cargo and drivers at the company.

At operation 814, the tailored or customized template document 128 is generated. In an example embodiment, the server 114 may populate the template document 126 with personalized data to generate or construct a tailored document 128, at operation 226. For example, the server 114 may retrieve a template document 126 having a selected template pattern 124 from the database 122, the server 114 may retrieve data associated with the input fields in the template pattern 124. The tailored document 128 may then be generated based on the selected template document 126 and the retrieved data from the database 122. For example, the retrieved data may be inserted into the selected template document 126 at a position corresponding to a placement position of the input field in the template document 126, thereby forming the tailored documents 128.

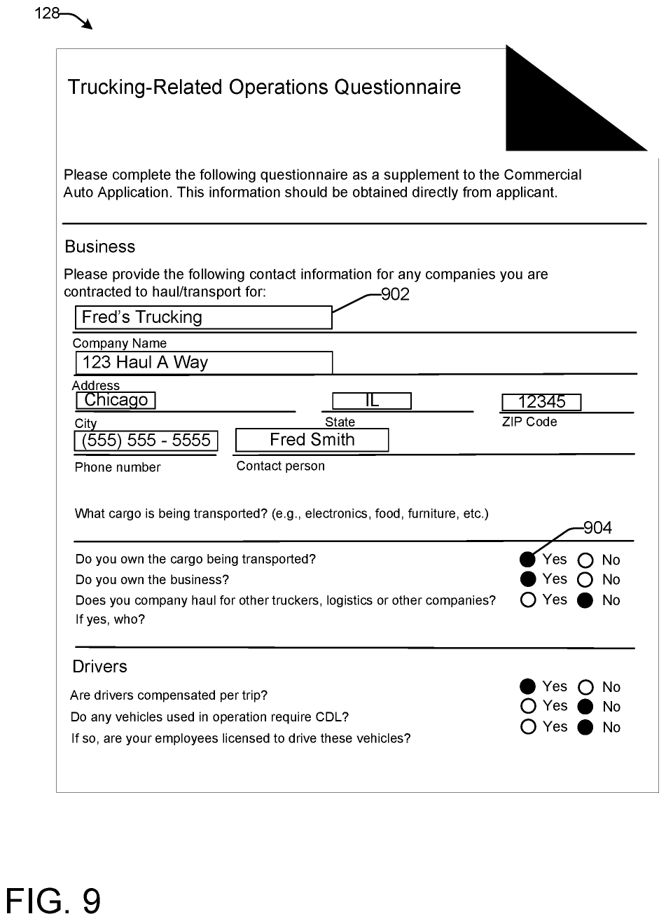

One example of a tailored template document 128 is shown in FIG. 9. As illustrated, the template document 126 of FIG. 5 has been populated with personalized data received from the business partner at client device 112 to generate the tailored document 128. In the example, which is intended to be a non-limiting, example for purposes of discussion, the server 114 receives the personalized data from the client device 112 in which to populate the template document 126. The content management system 116 of the server 114 converts the personalized data into one or more input of the template document 126. The input may then be used by the content generation engine 106 to populate or pre-fill a corresponding input field 502 of th template document 126. For example, an input in the template document 126 may relate to contact information of a business. In the example of FIG. 9, the server 114 receives the personalized data from the client device 112 (e.g., receives the company name, company address, company phone and company contact person) and populates the personalized data into the corresponding input field 502 in the template document 126. For example, the personalized data relating to the company name (e.g., Fred's Trucking) will be populated into the company name input field 502 of the template document 126. Similarly, the server 114 receives personalized data from the client device 112 relating to information about the company, such as the type of company (e.g., trucking), drivers of the company and cargo transported by the drivers. This personalized data may also be populated into the template document 126. For example, input field 502 may be populated to select “yes” when the personalized data from the client device 112 provides a response to “Are drivers compensated per trip?”

Once the template document 126 has been populated with the personalized data, a communication, including the tailored document 126, may be sent to the business partner at client device 112 for distribution to customers, at operation 816.

Embodiments of the insurance workflow management system 100 allow users to create visually appealing and customer-specific templates by specifying, the pattern generated in an associated template document. Additionally, by populating input fields with personalized data, embodiments. enable the template documents to be used and re-used in a number of different contexts. As an example, a single template may be used with a number of different solutions, as the input fields within the template may be populated with solution-specific data. In this mariner, embodiments of the disclosure provide a more efficient content generation process. Additionally, embodiments of the insurance workflow management system 100 provide an improved template creation process by allowing the user to format the template using a graphical interface that depicts how the resulting templated will be formatted (i.e., how the template will be patterned). This allows a user to visualize the formatting and pattern that content generated using the template will have during creation of the template. As such, embodiments of the disclosure provide a more intuitive and efficient interface for creating templates. In some embodiments, the insurance workflow management system 100 improves the efficiency of document creation by formatting content and selecting patterns for use in the templates. For example, the appearance of the document may be modified by adjusting formatting elements (e.g., onscreen elements) and selection of different patterns. Furthermore, the documents may be populated with information from an external source (e.g., a database). As an additional advantage, by populating the documents with up-to-date information from an external source, the system improves the quality of the document by ensuring that current information is used in the creation of the document. This may result in a substantial time savings for the user. Moreover, as documents may require updates based on state regulations or other requirements, the insurance workflow management system 100 provides a mechanism in which to modify the documents according to these regulations and requirements, while still providing a mechanism in which to populate the documents with personalized information. As the number of documents generated by the insurance workflow management system 100 may be voluminous, the system improves the efficiencies of generating such documents.

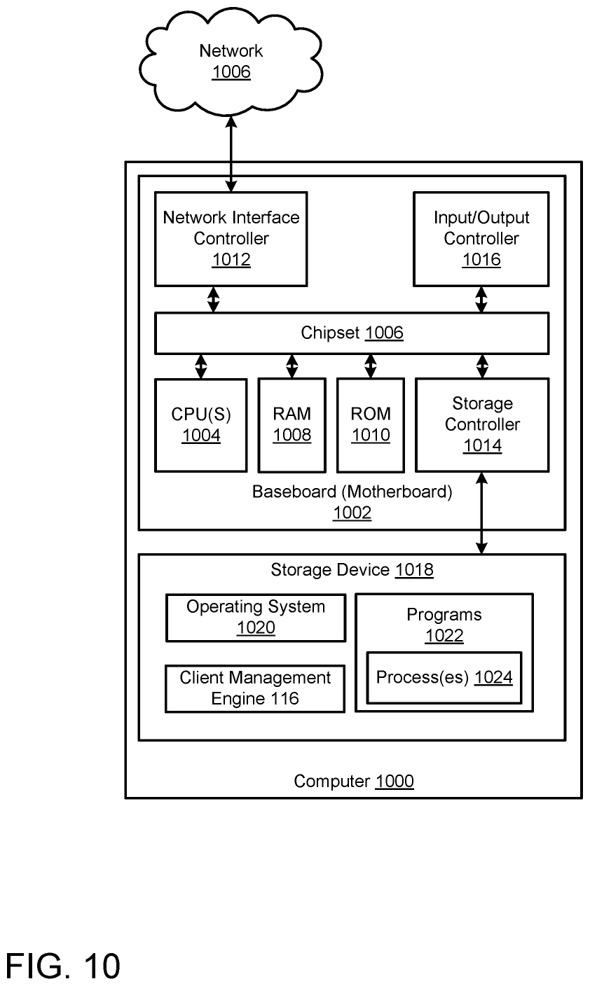

FIG. 10 shows an example computer architecture for a computer 1000 capable of executing program components for implementing the functionality described herein. The computer architecture shown in FIG. 10 illustrates a conventional server computer, workstation, desktop computer, laptop, tablet, network appliance, e-reader, smartphone, or other computing device, and can be utilized to execute any of the software components presented herein. The server computer 1000 may, in some examples, correspond to a server or client device, such as the server 114 or client device 112 described herein.

The computer 1000 includes a baseboard 1002, or “motherboard,” which is a printed circuit board to which a multitude of components or devices can be connected by way of a system bus or other electrical communication paths. In one illustrative configuration, one or more central processing units (“CPUs”) 1004 operate in conjunction with a chipset 1006. The CPUs 1004 can be standard programmable processors that perform arithmetic and logical operations necessary for the operation of the computer 1000.

The CPUs 1004 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 1006 provides an interface between the CPUs 1004 and the remainder of the components and devices on the baseboard 1002. The chipset 1006 can provide an interface to a RAM 1008, used as the main memory in the computer 1000. The chipset 1006 can further provide an interface to a computer-readable storage medium such as a read-only memory (“ROM”) 1010 or non-volatile RAM (“NVRAM”) for storing basic routines that help to startup the computer 1000 and to transfer information between the various components and devices. The ROM 1010 or NVRAM can also store other software components necessary for the operation of the computer 1000 in accordance with the configurations described herein.

The computer 1000 can operate in a networked environment using logical connections to remote computing devices and computer systems through a network, such as the network 1008. The chipset 1006 can include functionality for providing network connectivity through a Network Interface Controller (NIC) 1012, such as a gigabit Ethernet adapter. The NIC 1012 is capable of connecting the computer 1000 to other computing devices over the network 1008. It should be appreciated that multiple NICs 1012 can be present in the computer 1000, connecting the computer to other types of networks and remote computer systems. In some instances, the NICs 1012 may include at least on ingress port and/or at least one egress port.

The computer 1000 can be connected to a storage device 1018 that provides non-volatile storage for the computer. The storage device 1018 can store an operating system 1020, programs 1022, and process(es) 1024. The storage device 1018 can be connected to the computer 1000 through a storage controller 1014 connected to the chipset 1006. The storage device 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 1000 can store data on the storage device 1018 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 1018 is characterized as primary or secondary storage, and the like.

For example, the computer 1000 can store information to the storage device 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 1000 can further read information from the storage device 1018 by detecting the physical states or characteristics of one or more particular locations within the physical storage units.

In addition to the mass storage device 1018 described above, the computer 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 1000. In some examples, the operations performed by a computing system may be supported by one or more devices similar to computer 1000. Stated otherwise, some or all of the operations described herein may be performed by one or more computer devices 1000 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 1018 can store an operating system 1020 utilized to control the operation of the computer 1000. According to one embodiment, the operating system comprises the LINUX operating system. According to another embodiment, the operating system comprises the WINDOWS® SERVER operating system from MICROSOFT Corporation of Redmond, Wash. According to further embodiments, the operating system can comprise the UNIX operating system or one of its variants. It should be appreciated that other operating systems can also be utilized. The storage device 1018 can store other system or application programs and data utilized by the computer 1000.

In an example embodiment, the storage device 1018 or other computer-readable storage media is encoded with computer-executable instructions which, when loaded into the computer 1000, transform the computer from a general-purpose computing system into a special-purpose computer capable of implementing the embodiments described herein. These computer-executable instructions transform the computer 500 by specifying how the CPUs 1004 transition between states, as described above. According to one embodiment, the computer 1000 has access to computer-readable storage media storing computer-executable instructions which, when executed by the computer 1000, perform the various processes described above with regard to FIGS. 2, 6A, 6B, 7, 8A and 8B. The computer 1000 can also include computer-readable storage media having instructions stored thereupon for performing any of the other computer-implemented operations described herein.

As illustrated in FIG. 10, the storage device 1018 stores the content management engine 116, which are described above with reference to FIG. 1. Using instructions stored in the content management engine 116, the CPU(s) 1004 may be configured to track changes to inventory items, provide updated data to an external system that reflects the changes to the inventory item, etc.

The computer 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can provide output to a display, such as a computer monitor, a flat-panel display, a digital projector, a printer, or other type of output device. It will be appreciated that the computer 1000 might not include all of the components shown in FIG. 10, can include other components that are not explicitly shown in FIG. 10, or might utilize an architecture completely different than that shown in FIG. 10.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

As used herein, the term “based on” can be used synonymously with “based, at least in part, on” and “based at least partly on.”

As used herein, the terms “comprises/comprising/comprised” and “includes/including/included,” and their equivalents, can be used interchangeably. An apparatus, system, or method that “comprises A, B, and C” includes A, B, and C, but also can include other components (e.g., D) as well. That is, the apparatus, system, or method is not limited to components A, B, and C.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method for operation of an insurance workflow management system, comprising:
receiving, by a server in the insurance workflow management system, a transaction request from a client device, the transaction request including a set of insurance related requirements;
generating, by the server, a unique identifier that corresponds to the transaction request and the set of insurance related requirements from the client device;
selecting, by the server, a template pattern from a database operably connected to the server and storing a plurality of template patterns, the template pattern selected based at least in part on the set of insurance related requirements;
constructing, by the server, a template document based on the template pattern;
generating, by the server, a tailored communication document by populating the template document with personalized data received by the client device; and
sending, by the server, a first communication associated with the unique identifier and including the tailored communication document to the client device.

2. The method of claim 1, wherein the receiving further comprises:
collecting the set of insurance related requirements about the template pattern from the client device;
storing the transaction request and the set of insurance related requirements associated with the template pattern in the database as an inventory item, the inventory item associated with the unique identifier;
identifying the template pattern based on a sequence of queries presented to one or more business entities responsible for generating the template document;
assigning a set of tasks to the one or more business entities to generate the template document having the template pattern identified; and
sending a second communication, including the set of tasks assigned, to the one or more business entities responsible for handling the set of tasks assigned,
wherein the set of tasks assigned are added to a workflow of the one or more business entities.

3. The method of claim 2, wherein the receiving further comprises:
initiating, by the server, a request to update the set of insurance related requirements of the template document based on changes received from the client device; and
updating, by the server, the template document based on the changes made to the set of insurance related requirements.

4. The method of claim 2, further comprising:
initiating, by the server, the set of tasks assigned to the one or more business entities to review the template pattern selected, the review based on an analysis of the set of insurance related requirements included in the transaction request; and wherein
the template document is constructed upon approval of the template document assigned to the one or more business entities, and
the template document is stored in the database.

5. The method of claim 4, further comprising:
receiving, by the server, the template document approved by the one or more business entities for testing;
receiving, by the server, test data to process the template document by one or more business entities;
populating, by the server, the template document with the test data;
sending, by the server, the template document populated with the test data for review by the one or more business entities; and
delegating, by the server, approval of the template document populated with the test data to the one or more business entities.

6. The method of claim 5, wherein the first communication associated with the unique identifier and including the tailored communication document is sent to the client device upon approval of the template document populated with the test data.

7. The method of claim 5, further comprising
tracking, by the server, a status of the first communication and the template document using the unique identifier; and
updating, by the server, the database to reflect the status of the first communication.

8. The method of claim 2, wherein the set of insurance related requirements is acquired from input into a user interface at the client device.

9. The method of claim 8, wherein
the transaction request is a request for an insurance solution; and
the template document selected includes one or more fields that are pre-filled with the personalized data received from the client device.

10. The method of claim 1, further comprising acquiring the set of insurance related requirements from a user interface at the client device, the user interface including onscreen elements arranged for selection of a range of the set of insurance related requirements by a user of the client device.

11. A server in an insurance workflow management system, comprising:
one or more processors; and
one or more non-transitory computer-readable media storing computer-executable instructions that, when executed, cause the one or more processors to perform operations comprising:
receiving a transaction request from a client device, the transaction request including a set of insurance related requirements;
generating a unique identifier that corresponds to the transaction request and the set of insurance related requirements from the client device;
selecting a template pattern from a database operably connected to the server and storing a plurality of template patterns, the template pattern selected based at least in part on the set of insurance related requirements;
constructing a template document based on the template pattern;
generating a tailored communication document by populating the template document with personalized data received by the client device; and
sending a first communication associated with the unique identifier and including the tailored communication document to the client device.

12. The server of claim 11, wherein the receiving further causes the one or more processors to perform operations comprising:
collecting the set of insurance related requirements about the template pattern from the client device;
storing the transaction request and the set of insurance related requirements associated with the template pattern in the database as an inventory item, the inventory item associated with the unique identifier;
identifying the template pattern based on a sequence of queries presented to one or more business entities responsible for generating the template document;
assigning a set of tasks to the one or more business entities to generate the template document having the template pattern identified; and
sending a second communication, including the set of tasks assigned, to the one or more business entities responsible for handling the set of tasks assigned,
wherein the set of tasks assigned are added to a workflow of the one or more business entities.

13. The server of claim 12, wherein the receiving further causes the one or more processors to perform operations comprising:
initiating a request to update the set of insurance related requirements of the template document based on changes received from the client device; and
updating the template document based on the changes made to the set of insurance related requirements.

14. The server of claim 12, further causes the one or more processors to perform operations comprising:
initiating the set of tasks assigned to the one or more business entities to review the template pattern selected, the review based on an analysis of the set of insurance related requirements included in the transaction request; and wherein
the template document is constructed upon approval of the template document assigned to the one or more business entities, and
the template document is stored in the database.

15. The server of claim 14, further causes the one or more processors to perform operations comprising:
receiving the template document approved by the one or more business entities for testing;
receiving test data to process the template document by one or more business entities;
populating the template document with the test data;
sending the template document populated with the test data for review by the one or more business entities; and
delegating approval of the template document populated with the test data to the one or more business entities.

16. The server of claim 15, wherein the first communication associated with the unique identifier and including the tailored communication document is sent to the client device upon approval of the template document populated with the test data.

17. The server of claim 15, further causes the one or more processors to perform operations comprising:
tracking a status of the first communication and the template document using the unique identifier; and
updating the database to reflect the status of the first communication.

18. The server of claim 11, wherein
the transaction request is a request for an insurance solution; and
the template document selected includes one or more fields that are pre-filled with the personalized data received from the client device.

19. The server of claim 11, further causes the one or more processors to perform operations comprising acquiring the set of insurance related requirements from a user interface at the client device, the user interface including onscreen elements arranged for selection of a range of the set of insurance related requirements by a user of the client device.

20. One or more non-transitory computer-readable media storing instructions that, when executed by one or more processors, cause the one or more processors to perform actions comprising:
collecting, by a server, insurance data from a client device, the insurance data including a request to the server;
selecting, by the server, a template pattern based on the insurance data in the request; and
constructing, by the server, a template document based on the template pattern, wherein the template document is populated with personalized insurance data to form a tailored document.
